(19) United States
(12) Patent Application Publication
(10) Pub. No.: US 2017/0039397 A1
(43) Pub. Date: Feb. 9, 2017

(54) ENCRYPTION/DECRYPTION APPARATUS, CONTROLLER AND ENCRYPTION KEY PROTECTION METHOD

(71) Applicant: Kabushiki Kaisha Toshiba, Tokyo (JP)

(72) Inventors: Kana Furuhashi, Kawasaki Kanagawa (JP); Hironori Nakanishi, Yokohama Kanagawa (JP)

(21) Appl. No.: 14/938,597

(22) Filed: Nov. 11, 2015

Related U.S. Application Data
(60) Provisional application No. 62/202,005, filed on Aug. 6, 2015.

(51) Int. Cl. G06F 21/78; H04L 9/08; G06F 21/62; G06F 21/72

(52) U.S. Cl. CPC G06F 21/78; G06F 21/72; H04L 9/0897; G06F 21/62; G06F 2221/2143

(57) ABSTRACT

According to one embodiment, a first encryption key stored in a volatile first storage is input to a data input circuit, the first encryption key input in the data input circuit is encrypted with a second encryption key stored in a volatile second storage, and the access to the data input circuit is limited while the first encryption key is encrypted.

### CROSS-REFERENCE TO RELATED APPLICATIONS

This application is based upon and claims the benefit of priority from U.S. Provisional Application No. 62/202,005, filed on Aug. 6, 2015; the entire contents of which are incorporated herein by reference.

### FIELD

Embodiment described herein relate generally to an encryption/decryption apparatus, a controller, and an encryption key protection method.

### BACKGROUND

There are encryption/decryption apparatuses that encrypt and decrypt data using an encryption key. The encryption/decryption apparatus stores the encryption key in a volatile storage medium (encryption key storage unit) that is typically embedded in the apparatus. The encryption/decryption apparatus is applied, for example, to a storage device such as a hard disk drive or a hybrid drive. Such a storage device stores data after encrypting the data, and decrypts the encrypted data when the data is read, thereby enhancing the security against data leakage.

By the way, an operation mode which works in the state that consumption electricity is reduced (power-saving mode) is sometimes provided in a storage device to which the encryption/decryption apparatus is applied or in an electronic device such as a personal computer (PC) on which the storage device is installed. Data is not read or written in the power-saving mode. Thus, the power supply to the encryption/decryption apparatus is to be limited. However, the encryption key needs to be held even in the power-saving mode. For example, an encryption key is encrypted with another encryption key and saved in a non-volatile storage medium before the device is in the power-saving mode. This saving can hold the encryption key in the power-saving mode. After the device returns from the power-saving mode, the encrypted encryption key is read from the storage medium and restored (decrypted). However, the encryption key may be leaked while being saved or restored.

### BRIEF DESCRIPTION OF THE DRAWINGS

FIG. 1 is a diagram of an exemplary configuration of a storage device according to an embodiment;

FIG. 2 is a diagram of an exemplary functional configuration related to encryption and decryption and included in a controller according to the embodiment;

FIG. 3 is a schematic diagram of an exemplary state of the controller while power is supplied according to the embodiment;

FIG. 4 is a sequence diagram of an exemplary encryption key configuring process according to the embodiment;

FIG. 5 is a sequence diagram of an exemplary encryption key saving process according to the embodiment; and

FIG. 6 is a sequence diagram of an exemplary encryption key restoring process according to the embodiment.

### DETAILED DESCRIPTION

In general, according to one embodiment, an encryption/decryption apparatus including a non-volatile storage medium, and a controller is provided. The controller includes a volatile first storage, a data input circuit, an encryption circuit, a data output circuit, a volatile second storage, an encryption key encryption circuit, and an access controller. The first storage stores a first encryption key. The data input circuit inputs data to be encrypted or decrypted. The encryption circuit encrypts or decrypts the data input in the data input circuit with the stored first encryption key. The data output circuit outputs the data encrypted or decrypted in the encryption circuit. The second storage stores a second encryption key. In a case where receiving an instruction to encrypt the first encryption key, the encryption key encryption circuit inputs the first encryption key stored in the first storage to the encryption circuit through the data input circuit, and makes the encryption circuit and make the encryption circuit encrypt the first encryption key with the stored second encryption key. The access controller limits the access to the data input circuit while the encryption circuit encrypts the first encryption key. Subsequently, the storage medium stores the encrypted first encryption key output from the data output circuit.

The encryption/decryption apparatus, controller, and encryption key protection method according to the embodiment will be described in detail with reference to the appended drawings. Note that the present invention is not limited to the embodiment.

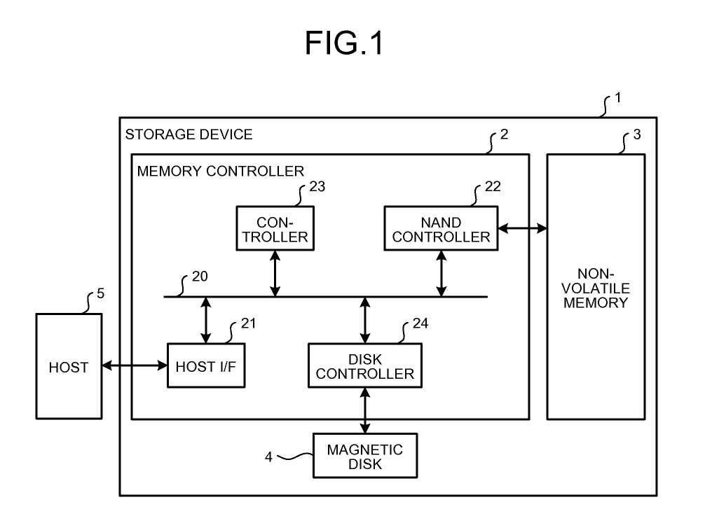

FIG. 1 is a diagram of an exemplary configuration of a storage device 1 according to the embodiment. The storage device 1 includes a memory controller 2, a non-volatile memory 3, and a magnetic disk 4. The storage device 1 can be connected to a host 5. FIG. 1 illustrates a state in which the storage device 1 is connected to the host 5. The host 5 may be an electronic device, such as a personal computer or a mobile terminal, or may be an external interface.

The storage device 1 is a hybrid drive including the non-volatile memory 3 and the magnetic disk 4. The hybrid drive is also referred to as a hybrid HDD or a solid state hybrid drive (SSHD).

The non-volatile memory 3 is a semiconductor memory such as a NAND flash memory. The non-volatile memory 3 is used, for example, as a write cache or a read cache. The non-volatile memory 3 is used also as a storage region to store an encrypted encryption key group, which will be described below.

The memory controller 2 controls writing of data to the non-volatile memory 3 and the magnetic disk 4 in accordance with a write command (request) from the host 5. The memory controller 2 controls reading of data from the non-volatile memory 3 and the magnetic disk 4 in accordance with a read command (request) from the host 5.

The memory controller 2 includes a host interface (I/F) 21, a NAND controller 22, a controller 23, and a disk controller 24. The units (modules, circuits, or components) included in the memory controller 2 are connected to each other through an internal bus 20. The controller 23 is connected to each of the host I/F 21, the NAND controller 22, and the disk controller 24 by a control line (not illustrated).

The controller 23 is a part of a control circuit (a circuit or circuitry), for example, a System-on-a-Chip (SoC), and generally controls operations of the storage device 1. For example, the controller 23 controls the writing to and the reading from the magnetic disk 4 through the disk controller 24. The controller 23 controls the writing to the non-volatile memory 3 and the reading from the non-volatile memory 3 through the NAND controller 22.

Furthermore, the controller 23 includes a functional unit (module, circuit, or component) that works as a controller to encrypt and decrypt data. Note that the functional configuration related to encryption and decryption will be described below.

The host I/F 21 perform a process in compliance with the interface standard between the host I/F 21 and the host 5. For example, the host I/F 21 outputs an instruction, data received from the host 5, or the like to the internal bus 20. The host I/F 21 transmits, for example, the data read from the non-volatile memory 3 and the magnetic disk 4 or the response from the controller 23 to the host 5.

The NAND controller 22 writes data to or reads data from the non-volatile memory 3 under the control by the controller 23. The disk controller 24 writes data to or reads data from the magnetic disk 4 under the control by the controller 23.

The storage device 1 having the configuration described above further includes an operation mode in which the storage device 1 operates while reducing the power consumption (power-saving mode). In the power-saving mode, the power supply to the non-volatile memory 3 stops and a part of power supply to the controller 23 stops. Note that some of the function units included in the controller 23 can perform the control related to the power-saving mode. Alternatively, the other controller such as a power controller (not illustrated) that controls the power supply can perform the control related to the power-saving mode. Similarly, the host 5 can gives an instruction to shift the storage device 1 to the power-saving mode, or the controller 23 or the other controller such as an electricity controller can alternatively give the instruction.

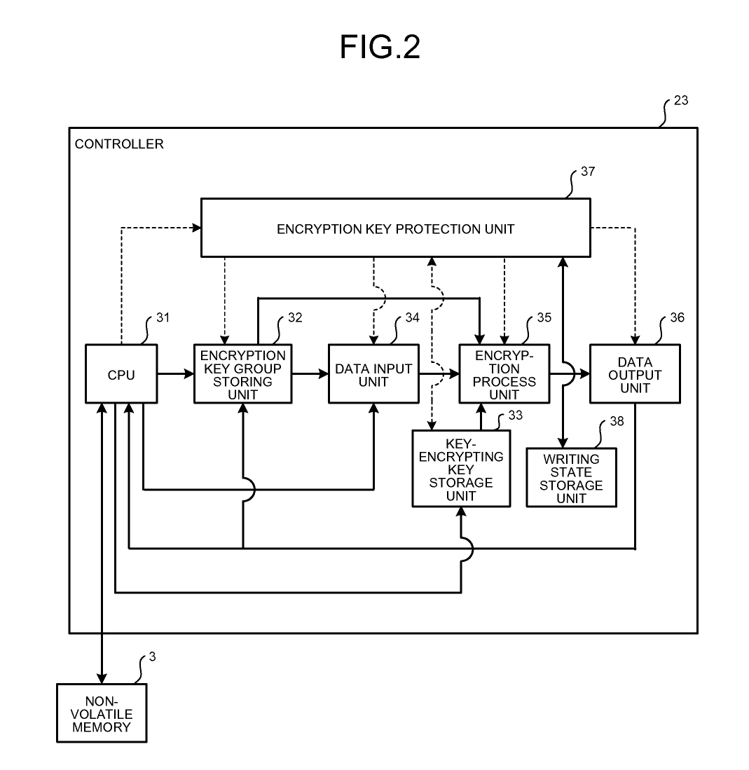

The functional configuration included in the controller 23 that works as a controller for encryption and decryption will be described next. FIG. 2 is a diagram of an exemplary functional configuration related to encryption and decryption and included in the controller 23. As illustrated in FIG. 2, the controller 23 includes a Central Processing Unit (CPU) 31, an encryption key group storing unit 32, a key-encrypting key storage unit 33, a data input unit 34 (a data input circuit), an encryption process unit 35 (an encryption circuit), a data output unit 36 (a data output circuit), an encryption key protection unit 37, and a writing state storage unit 38.

In FIG. 2, each of solid lines among the functional units is a data line, and each of dashed lines among the functional units is a control line. The controller 23 illustrated in FIG. 2 corresponds to a controller according to the present embodiment. Similarly, the configuration obtained by adding the non-volatile memory 3 to the controller 23 corresponds to the encryption/decryption apparatus according to the present embodiment. Note that the illustration of the NAND controller 22 is not included in FIG. 2.

The encryption key group storing unit 32 includes a volatile memory such as a Static Random Access Memory (SRAM), and is provided in the circuit of the controller 23. The encryption key group storing unit 32 stores a plurality of encryption keys (an encryption key group) used to encrypt and decrypt data. The encryption key is prepared, for example, for each set of tracks of the magnetic disk 4.

Similarly to the encryption key group storing unit 32, the key-encrypting key storage unit 33 includes a volatile memory such as an SRAM, and is provided in the circuit of the controller 23. The key-encrypting key storage unit 33 stores an encryption key used to encrypt the encryption key group (hereinafter, referred to as a key-encrypting key). In this example, there is only one key-encrypting key while there is a plurality of encryption keys. Thus, the storage capacity of the key-encrypting key storage unit 33 is smaller than the storage capacity of the encryption key group storing unit 32.

The data input unit 34 receives an input of data to be encrypted or decrypted, and inputs (outputs) the data to the encryption process unit 35. For example, the data input unit 34 inputs the user data that is transmitted from the host 5 and to be encrypted. The data input unit 34 inputs also the user data that is read from the magnetic disk 4 and to be decrypted (the encrypted data). Note that the data can be input to the data input unit 34 through any input channel. For example, the data input unit 34 can be configured to receive the user data (encrypted data) from the non-volatile memory 3 through a data input line (not illustrated). Alternatively, the data input unit 34 can receive the user data (encrypted data) through the CPU 31.

Alternatively, for example, to encrypt (save) an encryption key group with the key-encrypting key stored in the key-encrypting key storage unit 33, the data input unit 34 inputs the encryption key group as data to be encrypted. On the other hand, to decrypt (restore) an encrypted encryption key group (the encrypted encryption-key group), the data input unit 34 inputs the encryption key group as data to be decrypted.

The encryption key group stored in the encryption key group storing unit 32 is directly input to the encryption process unit 35 in a normal process for encrypting or decrypting the user data with the encryption key group in the present embodiment. Note that, however, the input is not limited to the embodiment. The encryption key group can be input through the data input unit 34.

The encryption process unit 35 encrypts or decrypts the data input in the data input unit 34 with the encryption key (the encryption key group or the key-encrypting key). The encryption process unit 35 can use, for example, a general-purpose encryption/decryption circuit. Note that the encryption process unit 35 can use any encryption and decryption method.

Specifically, the encryption process unit 35 encrypts the user data, which is input in the data input unit 34 and to be encrypted, with the encryption key group stored in the encryption key group storing unit 32. Similarly, the encryption process unit 35 encrypts the encryption key group, which is input in the data input unit 34 and to be encrypted, with the key-encrypting key stored in the key-encrypting key storage unit 33. The user data encrypted with the encryption key group is referred to as “encrypted data” hereinafter. The encryption key group encrypted with the key-encrypting key is referred to as an “encrypted encryption-key group”.

Furthermore, the encryption process unit 35 decrypts the encrypted data, which is input in the data input unit 34 and to be decrypted, with the encryption key group stored in the encryption key group storing unit 32. Similarly, the encryption process unit 35 decrypts the encrypted encryption key, which is input in the data input unit 34 and to be decrypted, with the key-encrypting key stored in the key-encrypting key storage unit 33. Note that, to encrypt and decrypt the user data with the encryption key group, the encryption process unit 35 uses an encryption key appropriate for the track to which the user data is written or from which the user data is read, in the encryption key group.

The data output unit 36 outputs the data encrypted or decrypted in the encryption process unit 35. For example, the data output unit 36 outputs the encrypted data or encrypted encryption-key group that is encrypted in the encryption process unit 35 to the non-volatile memory 3. The data output unit 36 outputs also the user data decrypted in the encryption process unit 35 to the non-volatile memory 3. Note that the data can be output from the data output unit 36 to the non-volatile memory 3 through any output channel. For example, the data output unit 36 can be configured to output data to the non-volatile memory 3 through a data output line (not illustrated). Alternatively, the data output unit 36 can be configured to output the data to the non-volatile memory 3 through the CPU 31.

The data output unit 36 stores the encryption key group, which is decrypted in the encryption process unit 35, in the encryption key group storing unit 32 by outputting the decrypted encryption key group to the encryption key group storing unit 32.

The CPU 31 is a processor to control the controller 23. The CPU 31 generates an encryption key group and a key-encrypting key and stores them in the encryption key group storing unit 32 and the key-encrypting key storage unit 33. The CPU 31 is configured to be able to access the data input unit 34 and the data output unit 36. Note that, when each data item is input or output through the CPU 31, the CPU 31 functions as an input and output controller.

By the way, when the storage device 1 is shifted to the power-saving mode, data is not read from and written to the magnetic disk 4. Thus, the power supply to the controller 23 is to be limited. However, the encryption key group needs to be held even in the power-saving mode. For example, the power supply to the encryption key group storing unit 32 that stores the encryption key group is maintained and the power supply to the other functional units is stopped in a conventional technique when the storage device 1 is shifted to the power-saving mode.

In the present embodiment, the encryption key group storing unit 32 stores at least the amount of data of the encryption key group. This means that the power consumed by the encryption key group storing unit 32 increases depending on the amount of data stored in the encryption key group storing unit 32.

In light of the foregoing, the controller 23 according to the present embodiment saves the encryption key group, which is encrypted with the key-encrypting key stored in the key-encrypting key storage unit 33, onto the non-volatile memory 3 before the storage device 1 is shifted to the power-saving mode. When the storage device 1 returns from the power-saving mode, the controller 23 restores the encryption key group, which is obtained by reading the encrypted encryption-key group from the non-volatile memory 3 and decrypting the encrypted encryption-key group with the key-encrypting key, onto the encryption key group storing unit 32.

The above-mentioned configuration for saving and restoring data can restore the data to the state before the storage device 1 is shifted to the power-saving mode, by maintaining the power supply to the key-encrypting key storage unit 33, which consumes a lower electricity than the encryption key group storing unit 32 does, instead of the power supply to the encryption key group storing unit 32. Thus, the configuration can further save the power in comparison with the conventional technique that maintains the power supply to the encryption key group storing unit 32. Furthermore, the encryption key group stored in the non-volatile memory 3 placed outside the controller 23 is encrypted with the key-encrypting key stored in the key-encrypting key storage unit 33. This encryption can secure the security.

Note that the data input unit 34 and the data output unit 36 holds a plaintext encryption key group when an encryption key group is encrypted or decrypted. In such a case, for example, the access from the input and output controller (CPU 31) can cause the leakage of the plaintext encryption key group from the data input unit 34 or the data output unit 36. The access from the input and output controller (CPU 31) can also cause, for example, the leakage or rewriting of the key-encrypting key in the key-encrypting key storage unit 33.

In light of the foregoing, the controller 23 according to the present embodiment improves the security for the encryption key group and the key-encrypting key, using the encryption key protection unit 37 and the writing state storage unit 38.

Specifically, to save the encryption key group stored in the encryption key group storing unit 32 onto the non-volatile memory 3, the CPU 31 sets (instructs to adopt) an operation mode in which the encryption key group is encrypted (hereinafter, referred to as an encryption key encrypting mode) to the encryption key protection unit 37 in the present embodiment. Alternatively, to restore the encryption key group (encrypted encryption-key group) stored in the non-volatile memory 3 to the encryption key group storing unit 32, the CPU 31 sets an operation mode in which the encrypted encryption key group is decrypted (hereinafter, referred to as an encryption key decrypting mode) to the encryption key protection unit 37.

Note that the CPU 31 can set the encryption key encrypting mode at any time before the storage device 1 is shifted to the power-saving mode. For example, the CPU 31 can set the encryption key encrypting mode when the storage device 1 is started. The CPU 31 preferably sets the encryption key decrypting mode just after the storage device 1 returns from the power-saving mode.

The encryption key protection unit 37 is a functional unit that functions as an encryption key encryption circuit, an access controller, a first clearing circuit, an encryption key decryption circuit, a second clearing circuit, and a state management circuit in the present embodiment. The encryption key protection unit 37 controls the operation for encrypting or decrypting the encryption key group in accordance with the setting of the encryption key encrypting mode or the encryption key decrypting mode.

Specifically, when the encryption key encrypting mode is set, the encryption key protection unit 37 controls the data input unit 34 to input the encryption key group stored in the encryption key group storing unit 32 to the encryption process unit 35. The encryption key protection unit 37 further controls the encryption process unit 35 to perform an encrypting process with the key-encrypting key stored in the key-encrypting key storage unit 33.

While being in the encryption key encrypting mode, the encryption key protection unit 37 disables the access to the data input unit 34 by controlling (limiting) the access. For example, the encryption key protection unit 37 controls the data input unit 34 to return a fixed value such as an error code unrelated to the encryption key group in response to a read access requesting acquisition of the encryption key group.

When the encryption key encrypting mode is canceled, the encryption key protection unit 37 clears the data, which is, for example, about the encryption key group and stored in the data input unit 34 and the encryption process unit 35, and subsequently cancels the control on the access to the data input unit 34. This can prevent the encryption key group, which is not encrypted yet, from leaking from the data input unit 34.

On the other hand, when the encryption key decrypting mode is set, the encryption key protection unit 37 controls the encryption process unit 35 to perform a decrypting process with the key-encrypting key stored in the key-encrypting key storage unit 33.

While being in the encryption key decrypting mode, the encryption key protection unit 37 disables the access to the data output unit 36 by controlling (limiting) the access. For example, the encryption key protection unit 37 controls the data output unit 36 to return a fixed value, such as an error code unrelated to the encryption key group, in response to a read access requesting acquisition of the encryption key group.

When the encryption key decrypting mode is cancelled, the encryption key protection unit 37 clears the data, which is about the encryption key group and stored in the encryption process unit 35 and the data output unit 36, and subsequently cancels the control on the access to the data output unit 36. This can prevent the decrypted encryption key group from leaking from the data output unit 36.

The encryption key protection unit 37 further controls the access to the key-encrypting key storage unit 33 by cooperating with the writing state storage unit 38. In this example, the writing state storage unit 38 is a volatile storage device that stores the state information indicating whether the key-encrypting key has been configured (written) in the key-encrypting key storage unit 33. For example, in the case two values indicate whether the key-encrypting key is configured, the writing state storage unit 38 can be implemented with a storage device having at least one bit in storage capacity. Note that the key-encrypting key storage unit 33 and the writing state storage unit 38 can be different volatile memories or the same volatile memories.

When detecting that the key-encrypting key is written in the key-encrypting key storage unit 33, the encryption key protection unit 37 sets the state information stored in the writing state storage unit 38 as the state information indicating that the key-encrypting key has been configured. While the state information indicates that the key-encrypting key has been configured, the encryption key protection unit 37 further disables the access to the key-encrypting key storage unit 33 by controlling (limiting) the access. For example, the encryption key protection unit 37 controls the key-encrypting key storage unit 33 to return a fixed value such as an error code unrelated to the key-encrypting key in response to a read access requesting acquisition of the key-encrypting key. This control can protect the key-encrypting key stored in the key-encrypting key storage unit 33.

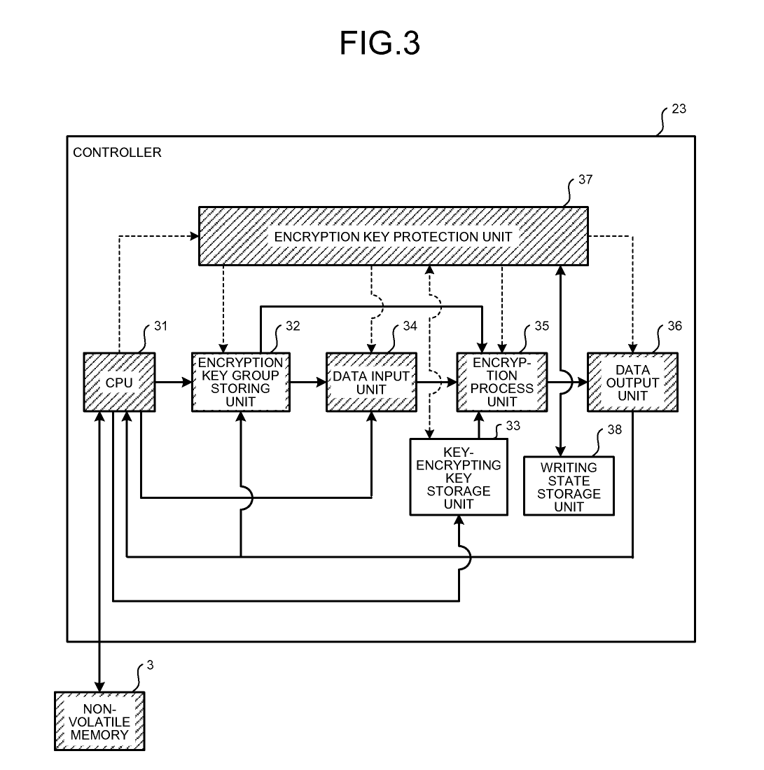

Note that, while the storage device 1 is in the power-saving mode, the power supply to the key-encrypting key storage unit 33 and the writing state storage unit 38 is maintained. FIG. 3 is a schematic diagram of an exemplary state of the controller 23 while power is supplied, in the power-saving mode. Note that the functional units to which the power supply is stopped are shaded with hatching in FIG. 3. In the power-saving mode as illustrated in FIG. 3, the power supply to the key-encrypting key storage unit 33 and the writing state storage unit 38 is maintained while the power supply to the other functional units (the CPU 31, the encryption key group storing unit 32, the data input unit 34, the encryption process unit 35, the data output unit 36, and the encryption key protection unit 37) is stopped. This can limit the time when the CPU 31 can write the key-encrypting key to the encryption key protection unit 37, for example, to the time when the storage device 1 is started, namely, when the writing state storage unit 38 is cleared.

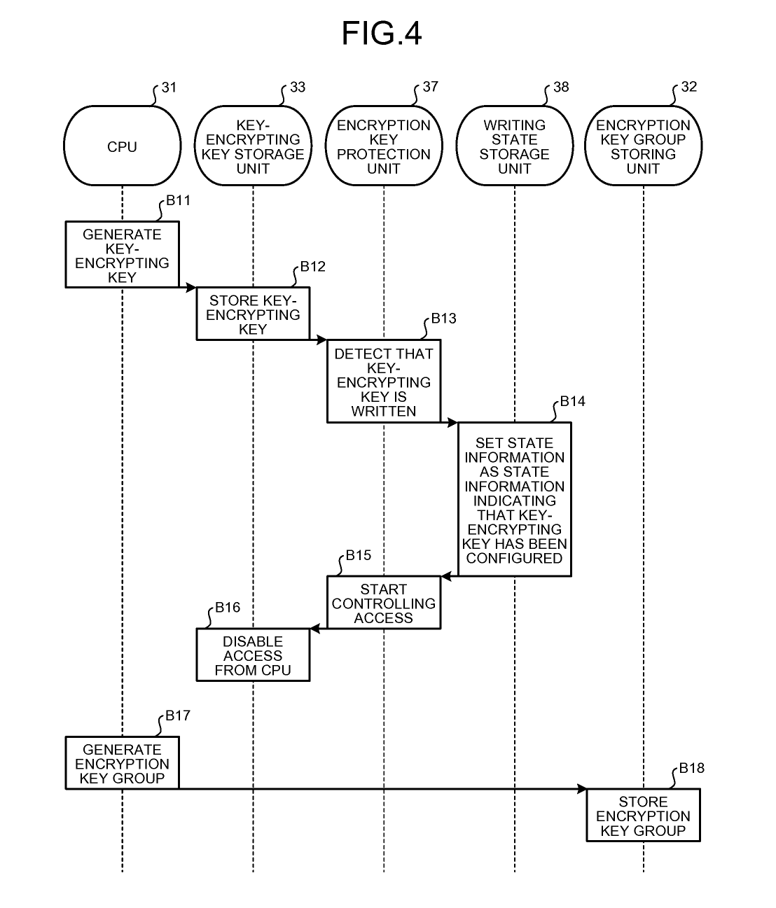

The operation of the controller 23 will be described hereinafter with reference to FIGS. 4 to 6. The operation to configure the encryption key (the encryption key group and the key-encrypting key) (an encryption key configuring process) will be described first with reference to FIG. 4. FIG. 4 is a sequence diagram of an exemplary encryption key configuring process. Note that the present process is an example on the assumption that the CPU 31 works as an input and output controller.

When the storage device 1 (the controller 23) is turned on the power and started, the CPU 31 generates a key-encrypting key (B11). Subsequently, the CPU 31 stores the generated key-encrypting key in the key-encrypting key storage unit 33 (B12). The key-encrypting key can be generated in any method. For example, the CPU 31 can generate the key-encrypting key based on random numbers. Alternatively, the CPU 31 can generate the key-encrypting key by cooperating with a security chip such as a Trusted Platform Module (TPM).

When detecting that the key-encrypting key is stored in the key-encrypting key storage unit 33 (B13), the encryption key protection unit 37 sets the state information stored in the writing state storage unit 38 as the state information indicating that the key-encrypting key has been configured (B14). Meanwhile, the encryption key protection unit 37 starts controlling the access to the key-encrypting key storage unit 33 with the set of the state information (B15). The key-encrypting key storage unit 33 disables the access from the CPU 31 with the start of the control on the access (B16). After that, the encryption key protection unit 37 continues controlling the access to the key-encrypting key storage unit 33 until the state information is cleared, in other words, until the storage device 1 is restarted (from powered off to powered on).

The CPU 31 generates an encryption key group (B17). Subsequently, the CPU 31 stores the generated encryption key group in the encryption key group storing unit 32 (B18). Then, the present process is completed. In this example, the encryption key group can be generated in any method. For example, the CPU 31 can generate the encryption key group based on random numbers, similarly to the key-encrypting key. Alternatively, the CPU 31 can generate the encryption key group by cooperating with a security chip such as a TPM.

The key-encrypting key is configured first in the encryption key configuring process illustrated in FIG. 4. Note that, however, the configuration is not limited to the example, and the encryption key group can be configured first. The access to the key-encrypting key storage unit 33 is controlled in the present embodiment. However, the control is not limited to the present embodiment. The access to the encryption key group storing unit 32 can also be controlled. When the access to the encryption key group storing unit 32 is also controlled, the encryption key protection unit 37 detects that the encryption key group is written to the encryption key group storing unit 32 and stores the state information indicating that the encryption key group is written, for example, in the writing state storage unit 38, similarly to the key-encrypting key storage unit 33. While the state information indicates that the encryption key group has been configured, the encryption key protection unit 37 disables the access from the CPU 31 to the encryption key group storing unit 32.

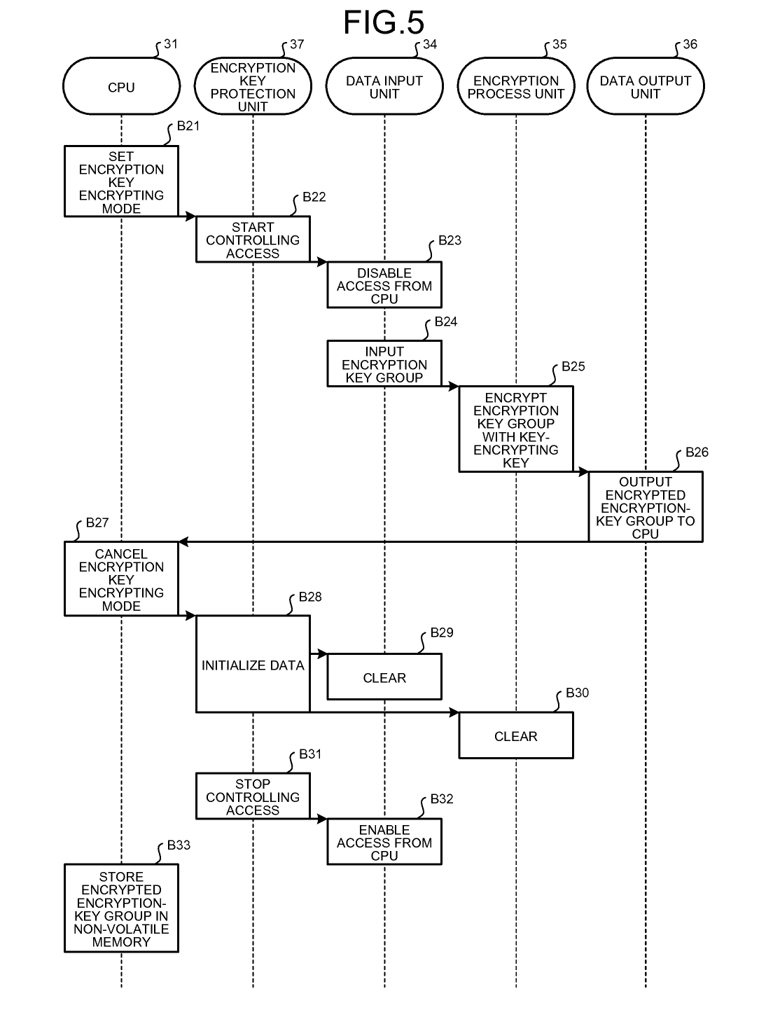

The operation to save the encryption key group (an encryption key saving process) will be described next with reference to FIG. 5. FIG. 5 is a sequence diagram of an exemplary encryption key saving process. Note that the present process is an example on the assumption that the CPU 31 works as an input and output controller.

First, the CPU 31 sets the encryption key encrypting mode to the encryption key protection unit 37 (B21). The encryption key protection unit 37 starts controlling the access to the data input unit 34 in response to the setting of the encryption key encrypting mode (B22). The data input unit 34 disables the access from the CPU 31 with the start of the control on the access (B23).

Next, the encryption key protection unit 37 controls the data input unit 34 to input the encryption key group stored in the encryption key group storing unit 32 to the encryption process unit 35 (B24). Under the control by the encryption key protection unit 37, the encryption process unit 35 encrypts the encryption key group input in the data input unit 34 with the key-encrypting key (B25). Under the control by the encryption key protection unit 37, the data output unit 36 outputs the encryption key group (encrypted encryption-key group) encrypted in the encryption process unit 35 to the CPU 31 (B26).

When obtaining the encrypted encryption-key group from the data output unit 36, the CPU 31 cancels the encryption key encrypting mode (B27). The encryption key protection unit 37 initializes the data input unit 34 and the encryption process unit 35 in response to the cancellation of the encryption key encrypting mode (B28). This clears the temporary data, such as the encryption key group, stored in the data input unit 34 and the encryption process unit 35 (B29 and B30). Note that the encryption key protection unit 37 can initialize the data output unit 36 at the time of B28.

Subsequently, the encryption key protection unit 37 stops controlling the access to the data input unit 34 (B31). The data input unit 34 enables the access from the CPU 31 with the stop of the control on the access (B32). Then, the CPU 31 stores (saves) the encrypted encryption-key group obtained from the data output unit 36 in the non-volatile memory 3 (B33), and the present process is completed.

The storage device 1 is shifted to the power-saving mode at an arbitrary time after the saving process described above is completed. In the power-saving mode, the power supply to the key-encrypting key storage unit 33 and the writing state storage unit 38 is maintained while the power supply to the units other than the key-encrypting key storage unit 33 and the writing state storage unit 38 is stopped as illustrated in FIG. 3.

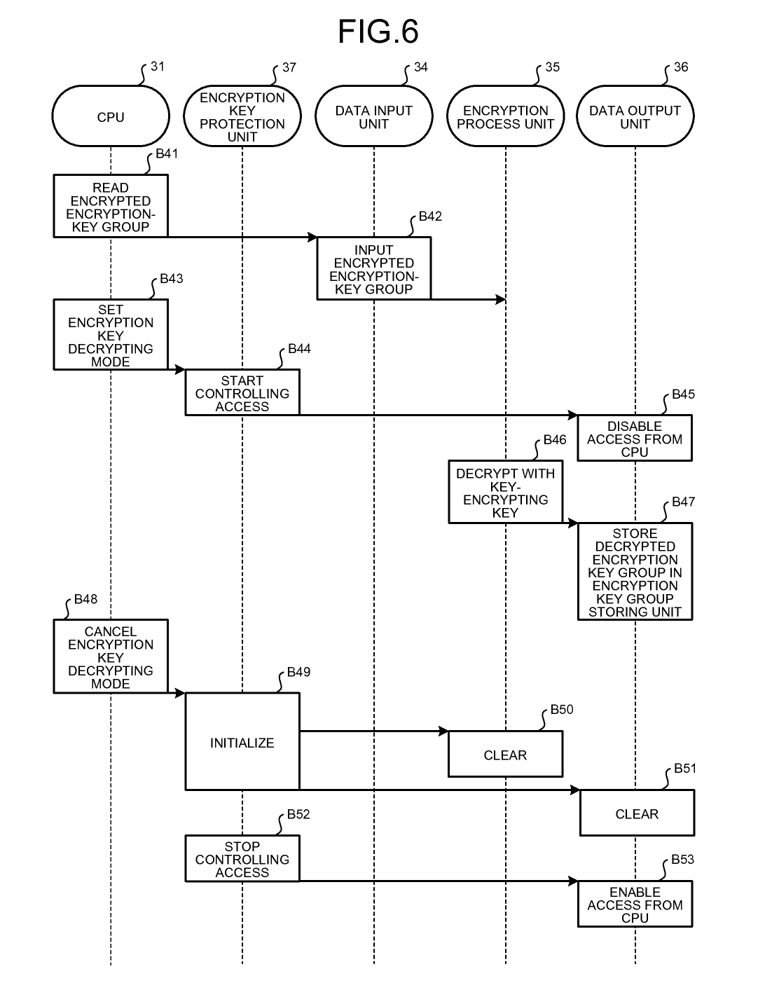

The operation to restore the encryption key group (an encryption key restoring process) will be described next with reference to FIG. 6. FIG. 6 is a sequence diagram of an exemplary encryption key restoring process. Note that the present process is performed after (just after) the storage device 1 returns from the power-saving mode. The present process is an example on the assumption that the CPU 31 works as an input and output controller.

First, the CPU 31 reads the encrypted encryption-key group from the non-volatile memory 3 (B41), and inputs the read encrypted encryption-key group to the data input unit 34 (B42). Next, the CPU 31 sets the encryption key decrypting mode to the encryption key protection unit 37 (B43).

The encryption key protection unit 37 starts controlling the access to the data output unit 36 in response to the setting of the encryption key decrypting mode (B44). The data output unit 36 disables the access from the CPU 31 with the start of the control on the access (B45).

Under the control by the encryption key protection unit 37, the encryption process unit 35 subsequently decrypts the encrypted encryption-key group input in the data input unit 34 with the key-encrypting key (B46). Under the control by the encryption key protection unit 37, the data output unit 36 subsequently outputs and stores the decrypted encrypted encryption-key group (the encryption key group) in the encryption key group storing unit 32 (B47). This restores the encryption key group to the state before the storage device 1 is shifted to the power-saving mode.

When the encryption key group is restored, the CPU 31 cancels the encryption key decrypting mode (B48). The encryption key protection unit 37 initializes the encryption process unit 35 and the data output unit 36 in response to the cancellation of the encryption key decrypting mode (B49). This clears the temporary data, such as the encryption key group, stored in the encryption process unit 35 and the data output unit 36 (B50 and B51).

Subsequently, the encryption key protection unit 37 stops controlling the access to the data output unit 36 (B52). The data output unit 36 enables the access from the CPU 31 with the stop of the control on the access (B53), and the present process is completed.

While an embodiment has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

The example in which the encryption/decryption apparatus (the controller) is applied to a hybrid drive (the storage device 1) has been described in the embodiment. However, the application is not limited to the example. The encryption/decryption apparatus (the controller) can be applied to another storage device (e.g. a Solid State Drive (SSD), a Hard Disk Drive (HDD), or a memory card) or an electronic device.

What is claimed is:

1. An encryption/decryption apparatus comprising:
a non-volatile storage medium; and
a controller,
the controller comprises:
a volatile first storage configured to store a first encryption key;
a data input circuit configured to input data to be encrypted or decrypted;
an encryption circuit configured to encrypt or decrypt data input in the data input circuit with the stored first encryption key;
a data output circuit configured to output data encrypted or decrypted in the encryption circuit;
a volatile second storage configured to store a second encryption key;
an encryption key encryption circuit configured to input the first encryption key stored in the first storage to the encryption circuit through the data input circuit and make the encryption circuit encrypt the first encryption key with the stored second encryption key in a case where an instruction to encrypt the first encryption key is given; and
an access controller configured to limit access to the data input circuit while the encryption circuit encrypts the first encryption key,
the storage medium storing the encrypted first encryption key output from the data output circuit.

2. The apparatus according to claim 1, wherein
the controller further comprises a first clearing circuit configured to clear data with respect to the first encryption key in a case where the instruction to encrypt the first encryption key is cancelled, the data being held in the data input circuit and the encryption circuit, and wherein
the access controller cancels the limitation of the access to the data input circuit after the first clearing circuit clears the data with respect to the first encryption key.

3. The apparatus according to claim 1, wherein
the controller further comprises an encryption key decryption circuit configured to make the encryption circuit decrypt the encrypted first encryption key, that is stored in the storage medium, with the second encryption key and store the decrypted first encryption key output from the data output circuit in the first storage in a case where an instruction to decrypt the first encryption key is given, and wherein
the access controller limits access to the data output circuit while the encryption circuit decrypts the encrypted first encryption key.

4. The apparatus according to claim 3, wherein
the controller further comprises a second clearing circuit configured to clear data, that is held in the encryption circuit and the data output circuit, with respect to the first encryption key in a case where the instruction to decrypt the first encryption key is cancelled, and wherein
the access controller cancels the limitation of the access to the data output circuit after the second clearing circuit clears the data with respect to the first encryption key.

5. The apparatus according to claim 1, wherein
the controller further comprises an input and output controller configured to be capable of inputting and outputting data by accessing the data input circuit and the data output circuit, and wherein
the access controller limits access from the input and output controller while the encryption circuit encrypts the first encryption key.

6. The apparatus according to claim 1, wherein
the controller further comprises:
a volatile third storage configured to store state information indicating a state of the second storage; and
a state management circuit configured to, when the second encryption key is written in the second storage, store a state information indicating that the second encryption key is written in the third storage, and wherein
the access controller limits access to the second storage while the state information indicates that the second encryption key is written.

7. The apparatus according to claim 6, wherein a power supply at least to the second storage and the third storage is maintained while a reduced power consumption state is maintained.

8. A controller comprising:
a volatile first storage configured to store a first encryption key;
a data input circuit configured to input data to be encrypted or decrypted;
an encryption circuit configured to encrypt or decrypt data input in the data input circuit with the stored first encryption key;
a data output circuit configured to output data encrypted or decrypted in the encryption circuit;
a volatile second storage configured to store a second encryption key;
an encryption key encryption circuit configured to input the first encryption key stored in the first storage to the encryption circuit through the data input circuit and make the encryption circuit encrypt the first encryption key with the stored second encryption key in a case where an instruction to encrypt the first encryption key is given; and
an access controller configured to limit access to the data input circuit while the encryption circuit encrypts the first encryption key.

9. The controller according to claim 8, further comprising:
a first clearing circuit configured to clear data with respect to the first encryption key in a case where the instruction to encrypt the first encryption key is cancelled, the data being held in the data input circuit and the encryption circuit, and wherein
the access controller cancels the limitation of the access to the data input circuit after the first clearing circuit clears the data with respect to the first encryption key.

10. The controller according to claim 8, further comprising:
an encryption key decryption circuit configured to make the encryption circuit decrypt the encrypted first encryption key with the second encryption key and store the decrypted first encryption key output from the data output circuit in the first storage in a case where an instruction to decrypt the first encryption key is given, and wherein
the access controller limits access to the data output circuit while the encryption circuit decrypts the encrypted first encryption key.

11. The controller according to claim 10, further comprising:
a second clearing circuit configured to clear data, that is held in the encryption circuit and the data output circuit, with respect to the first encryption key in a case where the instruction to decrypt the first encryption key is cancelled, and wherein
the access controller cancels the limitation of the access to the data output circuit after the second clearing circuit clears the data with respect to the first encryption key.

12. The controller according to claim 8, further comprising an input and output controller configured to be capable of inputting and outputting data by accessing the data input circuit and the data output circuit, and wherein
the access controller limits access from the input and output controller while the encryption circuit encrypts the first encryption key.

13. The controller according to claim 8, further comprising:
a volatile third storage configured to store state information indicating a state of the second storage; and
a state management circuit configured to, when the second encryption key is written in the second storage, store a state information indicating that the second encryption key is written in the third storage, and wherein
the access controller limits access to the second storage while the state information indicates that the second encryption key is written.

14. The controller according to claim 13, wherein a power supply at least to the second storage and the third storage is maintained while a reduced power consumption state is maintained.

15. An encryption key protection method performed in an encryption/decryption apparatus, the method comprising:
storing a first encryption key in a volatile first storage;
storing a second encryption key in a volatile second storage;
inputting data to be encrypted or decrypted;
encrypting or decrypting input data with the stored first encryption key;
outputting encrypted data or decrypted data;
inputting the stored first encryption key and making the input first encryption key to be encrypted with the stored second encryption key in a case where an instruction to encrypt the first encryption key is given; and
limiting access to input data while the first encryption key is encrypted.

16. The method according to claim 15, further comprising:
clearing data with respect to the first encryption key in a case where the instruction to encrypt the first encryption key is cancelled; and
cancelling the limitation of the access to the input data after the data with respect to the first encryption key is cleared.

17. The method according to claim 15, further comprising:
inputting the encrypted first encryption key and making the input encrypted first encryption key to be decrypted with the stored second encryption key in a case where an instruction to decrypt the first encryption key is given; and
limiting access to output data while the first encryption key is decrypted.

18. The method according to claim 17, further comprising:
clearing data with respect to the first encryption key in a case where the instruction to decrypt the first encryption key is cancelled; and
cancelling the limitation of the access to the output data after the data with respect to the first encryption key is cleared.

19. The method according to claim 15, further comprising:
limiting access to output data while the first encryption key is encrypted.

20. The method according to claim 15, further comprising:
storing state information indicating a state of the second storage in a volatile third storage;
storing the state information indicating that the second encryption key is written in the third storage, when the second encryption key is written in the second storage; and
limiting access to the second storage while the state information indicates that the second encryption key is written.
